(19) United States
(12) Patent Application Publication
(10) Pub. No.: US 2007/0129122 A1
(43) Pub. Date: Jun. 7, 2007

(54) Leaf-stripping device, especially for vines

(76) Inventors: Armin Pieroth, Bingen (DE); Udo Pieroth, Bingen (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/568,989

(22) PCT Filed: Aug. 9, 2004
(86) PCT No.: PCT/DE04/01789

§ 371 Date: Feb. 21, 2006

(30) Foreign Application Priority Data
Aug. 29, 2003 (DE) 103 40 231.4

(51) Int. Cl. A01F 12/40

(52) U.S. Cl. 460/112

(57) ABSTRACT

The invention relates to a leaf-stripping device, especially for vines, which comprises a suction blower and leaf-stripping tools mounted upstream thereof. The leaf-stripping tools comprise two parallel rotatable cylinders at least one of which is driven.

The invention pertains to a leaf-stripping device, especially for grapevines, with a suction blower and leaf-stripping tools arranged in front of it.

This type of leaf-stripping device is used for leaf-stripping of crops growing in a trellis, especially grapevines or fruit trees. The grapevines of the vineyards are freed of part of their foliage, for example, at the level of their grape zone, in which case not too many leaves are to be removed, in order to retain sufficient assimilation surface. Leaf stripping is carried out for better aeration of the grape zone and for a higher solar effect on the fruits, so that diseases are reduced and the fruits are directly exposed to plant protection agents. These effects lead to relatively healthy and ripe grapes, and therefore ultimately to a high-value wine.

Various leaf-stripping devices are known from practice, which are generally mounted in front of the right or left front wheel of a vineyard tractor.

FR 2 368 215 A and DE 29 31 564 A1 each disclose a leaf-stripping device in which several rotating blades are arranged as leaf-stripping tools in front of a suction blower. The leaves being separated are drawn into a plane of the cutting blades by the air stream generated by the suction blower, and the blades then separate them from the plants. A problem in these leaf-stripping devices is that relatively large amounts of fruit are also drawn in by the air stream and destroyed by the rotating cutting blades. To counter this, it is known, for example, from FR 2 390 084 A, EP 0 278 607 A1, and DE 295 18 392 U1 to arrange a grate in front of the leaf-stripping tools designed as rotating cutting blades, which prevents drawing the fruits into the region of the cutting blades.

WO 01/87047 also shows a leaf-stripping device with a complex design having a leaf-stripping head that includes a rotatable cylinder and a suction blower to generate an air stream flowing around the cylinder. A cutter bar is connected to the cylinder for leaf-stripping of grapevines, which is subject to a certain wear.

In addition, a leaf-stripping device is known from practice that, in order to position the fruits against the leaf-stripping device without damage, has a vertically aligned rubber cylinder. The rubber cylinder simultaneously prevents foreign bodies, for example, stakes, from reaching the blades connected behind it, in-between which a suction blower draws the foliage. This leaf-stripping device is considered protective of the grapes, but it is relatively expensive and is heavy, for which reason it can only be fastened to a relatively heavy-duty tractor that causes high soil compaction.

The underlying task of the invention is to devise a leaf-stripping device of the type just mentioned, which ensures reliable leaf stripping that protects the fruits in a simple and cost-effective design.

The task is solved according to the invention in that the leaf-stripping devices include two rotatable cylinders arranged parallel to each other, at least one of which is driven.

The foliage to be separated from the plants is drawn by means of the suction blower between the two cylinders, which press the leaves between them and tear them from the plants. The leaf-stripping therefore has a relatively simple, as well as light and cost-effective design.

According to an advantageous modification of the invention, the cylinders are designed so that the foliage is separated from the plants and the fruits of the plants are not damaged. For this purpose, the surfaces of the cylinders have relatively limited friction, which in conjunction with a natural wax layer on the surface of the fruits largely prevents the fruits from being pulled between the cylinders. Since the foliage has relatively high friction relative to the fruits, it is transported by the cylinders and plucked from the plants.

In order to increase the air flow of the suction blower for suction of the foliage, at least one of the cylinders preferably has grooves on the periphery. The width and depth of the grooves advantageously corresponds to roughly the size of the fruit. An additional sorting effect is produced by the grooves, since the fruits do not lie flat over the grooves like the foliage but cover them over a relatively large area [sic; see last sentence of Description], and especially with bunches of grapes, between whose fruits additional air channels are left, creating a comparatively low partial vacuum between the fruits and the cylinder. Therefore the fruits, which in any case can only be moved with difficulty by the air stream, do not enter the space between the cylinders. The grooves are preferably formed in the driven cylinder.

To avoid adhesion of the separated foliage to one of the cylinders, the driven cylinder is advantageously made from a plastic with a poorly wettable surface.

In one embodiment of the invention, the non-driven cylinder is spring-loaded against the driven cylinder. The non-driven cylinder here is advantageously supported at the front in a lever mechanism against which the pressure springs for the cylinder bear. The non-driven cylinder, i.e., the not directly driven cylinder, is therefore rotated by the cylinder driven by a motor. On the one hand, tolerance compensation is ensured by the spring-loaded lever mechanism, and on the other hand, so is the pressure against the opposite cylinder required to pluck the foliage from the plants.

In order to reliably guide the leaves through the two cylinders and then remove them from the plant, the non-driven cylinder preferably has an elastic peripheral surface. The peripheral surface of the non-driven cylinder is advantageously made from an elastomer. The elastomer can be applied, for example, in the form of a tube onto the peripheral surface of the cylinder. By selection of the materials of the two cylinders, namely, polyethylene on the one hand, and an elastomeric surface on the other, crushing the leaves and expressing plant juices is largely reduced, so that relatively few leaves or leaf parts contaminate the suction blower. To prevent any foliage from adhering to the cylinders, at least one of the cylinders has a foliage stripper extending over its length. If, for example, one cylinder has an elastomeric peripheral surface to which the foliage can adhere, the stripper is positioned immediately above the peripheral surface of the cylinder.

In order to provide a comparatively high leaf-stripping height in a trellis arrangement, the two cylinders are aligned vertically and arranged in a common flow channel with the suction blower. The air stream of the suction blower therefore transports the leaves into the region between the two cylinders, which grasp the leaves and remove them from the plant.

To achieve a pull-in region between the cylinders that grasps the leaves and rules out damage to the fruits, the diameter of the non-driven cylinder is advantageously chosen to be smaller than the diameter of the driven cylinder.

In order for a defined leaf-stripping region to be achieved, the two cylinders are preferably partly spanned on the side facing the foliage by a cover plate that has a cutout with an entry incline for the foliage. The cutout can naturally also be assigned a vertically movable aperture to change the leaf-stripping region. The cover plate is advantageously fastened to the front of the flow channel on the foliage side.

For particularly strong leaf stripping, up to almost complete leaf stripping, it is possible to arrange several pairs of cylinders, one behind the other. It is also conceivable for the cylinder pairs to be aligned offset relative to the foliage wall.

According to an advantageous modification of the inventive idea, the leaf-stripping device includes means for front-mounting on a vehicle, especially a tractor. If the leaf-stripping device is used on a tractor, its hydraulic system can be used, for example, to drive the driven cylinder.

It is understood that the features just mentioned and still to be explained below can be used not only in the stated combination, but also in other combinations. The scope of the present invention is only defined by the claims.

The invention is further explained below by means of the embodiment, with reference to the appended drawings. In the drawings:

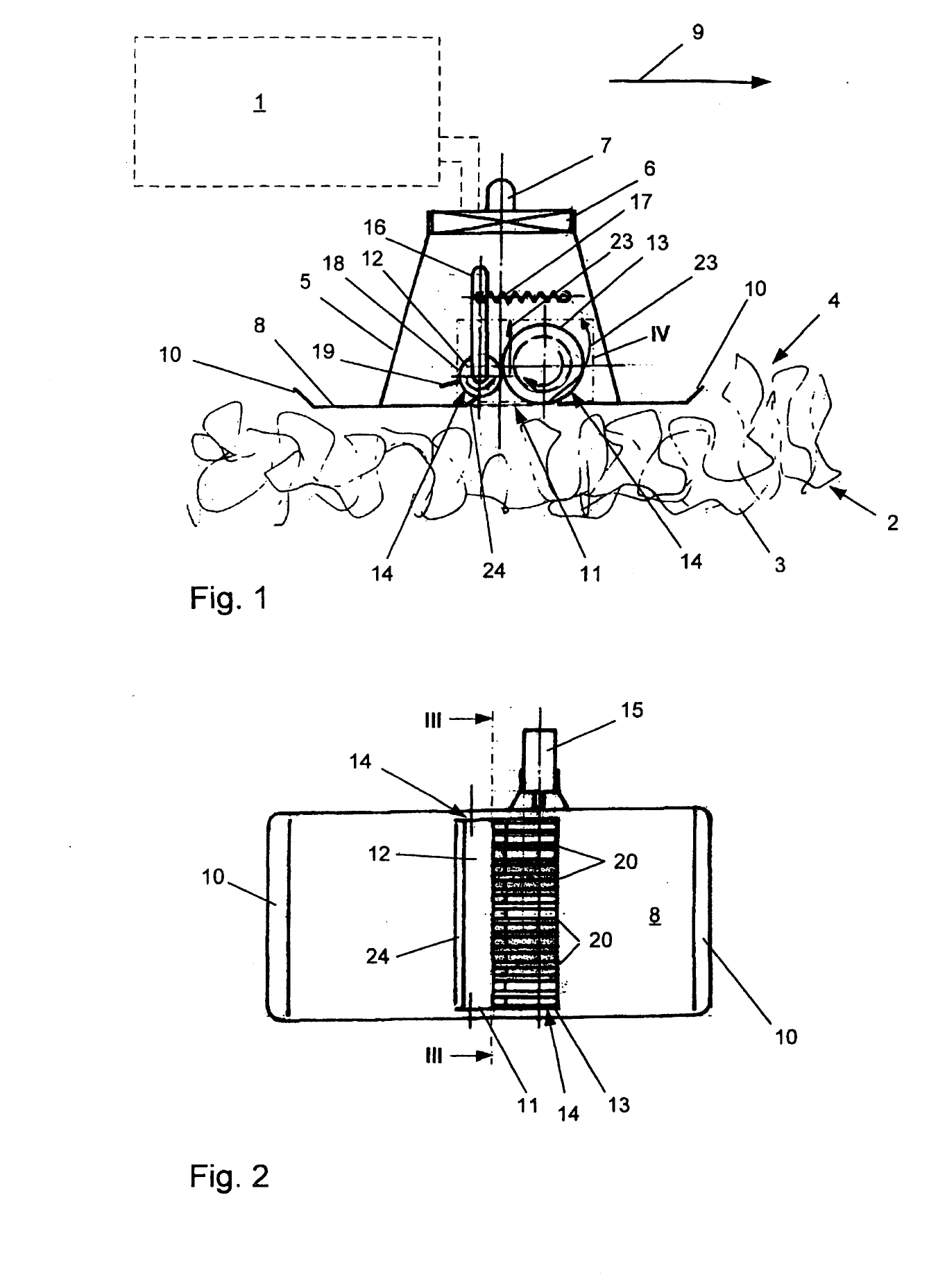

FIG. 1 is a partial section of a top view of the leaf-stripping device according to the invention,

FIG. 2 is a front view of the leaf-stripping device according to FIG. 1,

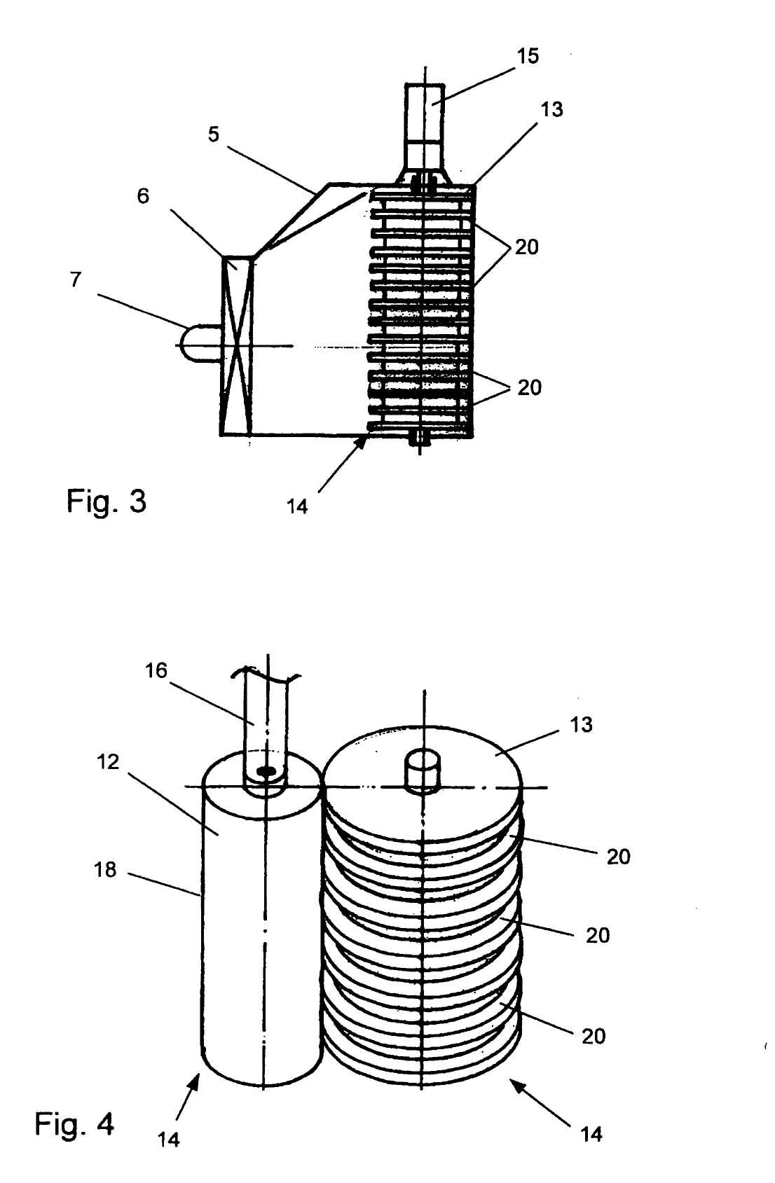

FIG. 3 is a partial section along line III-III according to FIG. 2,

FIG. 4 is an oblique view of a detail IV according to FIG. 1 and

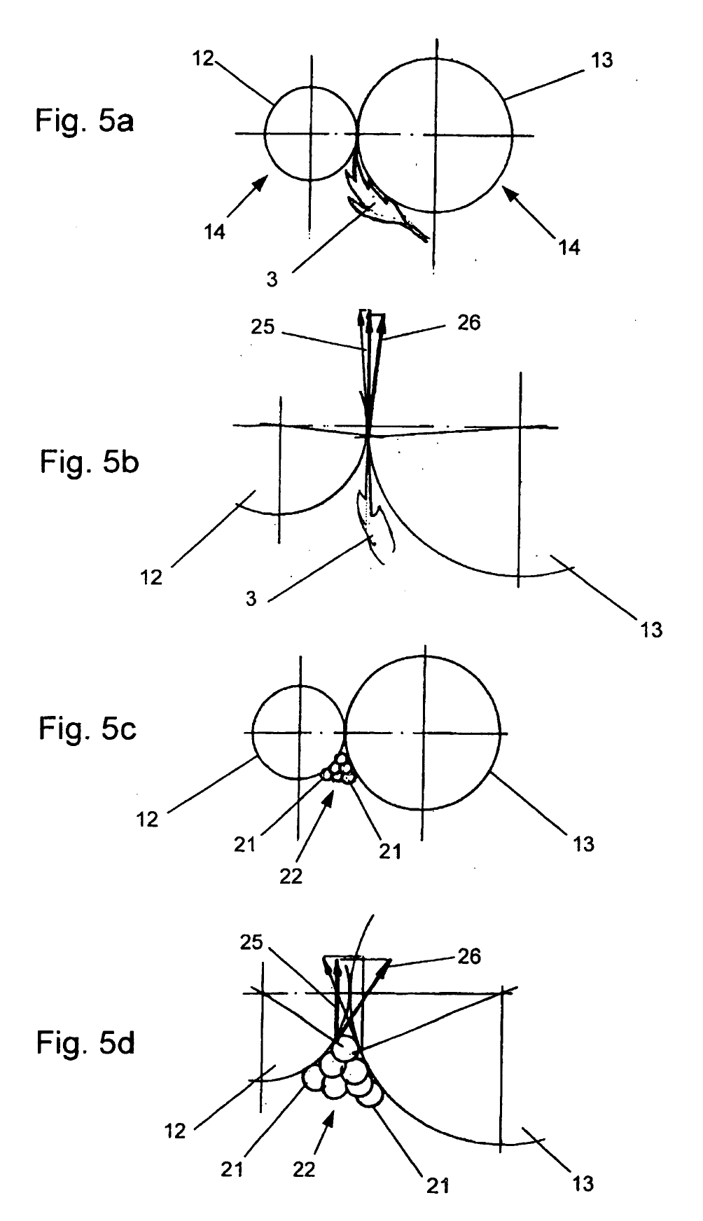

FIGS. 5a to 5d are schematic views of the method of operation of the leaf-stripping device.

The leaf-stripping device is mounted on the front of a schematically depicted tractor 1 and is transported by it along grapevines 2 growing in a trellis, in order to at least partially remove their leaves 3. For suction of the leaves 3 from a foliage wall 4 formed by the grapevines 2, the leaf-stripping device includes a suction blower 6, arranged in a funnel-shaped or cylindrical housing 5, which is driven by a motor 7. A cover plate 8 is provided on the side of the leaf-stripping device facing the foliage wall 4, which has offsets 10 facing away from the foliage wall 4 on the end, both in the working direction, depicted by an arrow 9, and in the direction opposite to it. A cutout 11 is situated in the cover plate 8, through which the leaves 3 being separated enter the effective region of the leaf-stripping tools 14, designed as cylinders 12, 13.

The two cylinders 12, 13, one of which is coupled to a drive motor 15, are mounted to rotate with their rotational axes in the vertical direction parallel to each other within housing 5. The non-driven cylinder 12 is accommodated at its front end in a lever mechanism 16 against which pressure springs 17 bear in order to force the non-driven cylinder 12 against the driven cylinder 13. In order for entrainment of the leaves 3 into the pull-in region between the two cylinders 12, 13 to be guaranteed, the non-driven cylinder 12 has a peripheral surface 18 made from an elastomer, and therefore elastic. To eliminate any leaves 3 still adhering to the elastic peripheral surface 18 of the non-driven cylinder 12 after leaf stripping, a stripper 19 is provided within housing 5 that extends over the entire length of the associated cylinder 12. The driven cylinder 13 is made from a poorly wettable plastic, for example, polyethylene, and has grooves 20 in the periphery whose width and depth correspond roughly to the size of a fruit 21 of a bunch of grapes 22.

During operation of the leaf-stripping device, it is moved by tractor 1 along the grapevines 2 being subjected to leaf stripping, so that the cover plate 8 is lightly pressed against the foliage wall 4. The connected suction blower 6 produces an air stream according to arrows 23 around the driven cylinder 13, which is promoted by its peripheral grooves 20. In the region of the non-driven cylinder 12 within cutout 11 of the cover plate 8, an angling-in 24 directed towards this cylinder 12 is provided, which, on the one hand, minimizes the air flow prevailing here and, on the other hand, places the leaves 3 being separated against this cylinder 12. The relatively easily movable leaves 3 are drawn by the air stream into the region between the two cylinders 12, 13, where they are clamped, because of the rotational movement and the prevailing friction, and plucked from the grapevines 2. The leaves removed in this way are removed by the air stream of the suction blower 6 from the region of the two cylinders 12, 13. Since the leaves 3 remain almost fully preserved, emergence of plant juices is minimized, for which reason almost no leaves 3 adhere to the suction blower 6.

The pull-in forces and friction forces acting during the leaf-stripping process on leaves 3 and fruits 21 of the bunch of grapes 22, which are shown by the arrows 25 and 26, are essentially determined by the dimensions, i.e., the thickness and diameter, of the leaf 3 and the fruit 21. During pulling-in of a relatively thin leaf 3, the prevailing pull-in forces are roughly as large as the friction forces, for which reason an increased tear-off force prevails relative to the much thicker fruit 21, on which much smaller pull-in forces and friction forces act. Because of the geometry of cylinders 12, 13 that determine the pull-in forces and friction forces, damage to the bunch of grapes 22 during leaf stripping is almost ruled out, since the geometry causes a certain sorting effect. This sorting effect is favored by the fact that the bunch of grapes 22, which is moved with relative difficult by the air stream of the suction blower 6, is not firmly pressed against the cylinders 12, 13. In addition, the skins of the fruits 21, like other types of fruit as well, have a natural wax layer with a relatively low friction coefficient, which largely reduces the friction forces prevailing between the fruits 21 and cylinders 12, 13. In addition, the pull-in forces are determined by the grooves 20 in the peripheral surface of the driven cylinder 13, since the leaves 3 cover the grooves 20 over a relatively large area, whereas air channels remain between fruits 21 of the bunch of grapes 22 and the grooves 20 because of point contact, for which reason suction of the bunch of grapes 22 against cylinders 12, 13 is relatively limited.

1. A leaf-stripping device, comprising:
a suction blower and leaf-stripping tools arranged in front of the suction blower, the leaf-stripping tools including two rotatable cylinders arranged substantially parallel to each other, at least one of the rotatable cylinders being coupled to a drive motor.

2-17. (canceled)

18. A leaf-stripping device according to claim 1, wherein the cylinders are designed so that foliage is separated from a plant, and fruits of the plant are not damaged.

19. A leaf-stripping device according to claim 1, wherein at least one cylinder has peripheral grooves.

20. A leaf-stripping device according to claim 19, characterized by the fact that the width and depth of each groove corresponds roughly to the size of a fruit.

21. A leaf-stripping device according to claim 19, wherein grooves are made in the at least one cylinder coupled to the drive motor.

22. A leaf-stripping device according to claim 1, wherein the driven cylinder is made from a plastic with a poorly wettable surface.

23. A leaf-stripping device according to claim 1, wherein one of the cylinders is not coupled to the motor and is spring-loaded against the other of the cylinders.

24. A leaf-stripping device according to claim 23, wherein the cylinder that is not coupled to the motor is supported in a lever mechanism against which pressure springs for the cylinder bear pressure.

25. A leaf-stripping device according to claim 1, wherein the cylinder that is not coupled to the motor includes an elastic peripheral surface.

26. A leaf-stripping device according to claim 25, wherein a peripheral surface of the cylinder that is not coupled to the motor includes an elastomer.

27. A leaf-stripping device according to claim 1, wherein at least one of the cylinders has a foliage stripper extending over its length.

28. A leaf-stripping device according to claim 1, wherein the two cylinders are aligned substantially vertically and are arranged in a common flow channel with the suction blower.

29. A leaf-stripping device according to claim 23, wherein a diameter of the cylinder that is not coupled to the motor is made smaller than the diameter of the other cylinder.

30. A leaf-stripping device according to claim 18, wherein the two cylinders are spanned partially by a cover plate arranged on a side facing the foliage that has a cutout with an entry incline for the foliage.

31. A leaf-stripping device according to claim 30, wherein the cover plate is fastened to the flow channel on a side facing the foliage.

32. A leaf-stripping device according to claim 1, further comprising a plurality of pairs of cylinders, arranged one behind the other.

33. A leaf-stripping device according to claim 1, further comprising means for mounting the device on the front of a vehicle.

34. A leaf-stripping device according to claim 1, wherein the vehicle is a tractor.
